(19) United States
(12) Patent Application Publication
(10) Pub. No.: US 2026/0003301 A1
(43) Pub. Date: Jan. 1, 2026

(54) IMAGE FORMING APPARATUS

(71) Applicant: CANON KABUSHIKI KAISHA, Tokyo (JP)

(72) Inventors: KEI HAYASHIDA, Tokyo (JP); NORITOMO YAMAGUCHI, Kanagawa (JP); AKINORI MITSUMATA, Tokyo (JP); HIROOMI MATSUZAKI, Shizuoka (JP); TORU OGUMA, Shizuoka (JP); KAZUKI MATSUMOTO, Shizuoka (JP); TATSURO HARADA, Shizuoka (JP)

(21) Appl. No.: 19/320,996

(22) Filed: Sep. 5, 2025

Related U.S. Application Data
(63) Continuation of application No. PCT/JP2024/009267, filed on Mar. 11, 2024.

(30) Foreign Application Priority Data
Mar. 14, 2023 (JP) 2023-039200

(51) Int. Cl. G03G 15/01; B41J 2/45; G03G 15/00; G03G 15/04; G03G 15/08

(52) U.S. Cl. CPC G03G 15/0121; B41J 2/45; G03G 15/011; G03G 15/0189; G03G 15/04054; G03G 15/0875; G03G 15/0898; G03G 15/6552

(57) ABSTRACT

An image forming apparatus includes an apparatus main body that includes first and second developing units, an air pump unit, a first toner container accommodating first toner and including a first intake port and a first discharge port, a second container accommodating second toner and including a second intake port and a second discharge port, a first passage communicating with the first discharge port and extending to the first developing container, and a second passage communicating with the second discharge port and extending to the second developing container. The first toner is passed through the first passage to replenish the first developing container by the air discharged from the first discharge port and flowed into the first passage. The second toner is passed through the second passage to replenish the second developing container by the air discharged from the second discharge port and flowed into the second passage.

### CROSS-REFERENCE TO RELATED APPLICATIONS

This application is a Continuation of International Patent Application No. PCT/JP2024/009267, filed Mar. 11, 2024, which claims the benefit of Japanese Patent Application No. 2023-039200, filed Mar. 14, 2023, both of which are hereby incorporated by reference herein in their entirety.

### BACKGROUND

### Field

The present disclosure relates to an image forming apparatus and a toner container used therein.

### Background Art

Electrophotographic image forming apparatuses configured to replenish developing containers therein with toner using toner containers detachably attachable to the image forming apparatuses have been known. PTL 1 describes a configuration that enables easy toner replenishment without replacing the development container by attaching a replenishment pack to the image forming apparatus.

### CITATION LIST

### Patent Literature

PTL 1: Japanese Patent Application Laid-Open No. 2020-154300

### SUMMARY

The present disclosure is directed to providing a new form of image forming apparatus that conveys toner with air and toner container that is used therein.

According to a first aspect of the present disclosure, an image forming apparatus for forming an image on a recording material includes an apparatus main body including a first developing unit and a second developing unit, the first developing unit including a first developing container configured to accommodate first toner and a first developing roller configured to bear the first toner, the second developing unit including a second developing container configured to accommodate second toner and a second developing roller configured to bear the second toner, a pump unit configured to send out air, a first toner container configured to accommodate the first toner and be detachably attachable to the apparatus main body, the first toner container including a first intake port configured to take in the air and a first discharge port configured to discharge the first toner using the air taken in from the first intake port, a second toner container configured to accommodate the second toner and be detachably attachable to the apparatus main body, the second toner container including a second intake port configured to take in the air and a second discharge port configured to discharge the second toner using the air taken in from the second intake port, a first passage communicating with the first discharge port and extending to the first developing container, and a second passage communicating with the second discharge port and extending to the second developing container. The image forming apparatus is configured such that the first toner discharged from the first discharge port is passed through the first passage to replenish the first developing container by the air discharged from the first discharge port and flowed into the first passage. The image forming apparatus is configured such that the second toner discharged from the second discharge port is passed through the second passage to replenish the second developing container by the air discharged from the second discharge port and flowed into the second passage.

According to a second aspect of the present disclosure, a toner container includes a first chamber configured to accommodate toner, the first chamber including a discharge port configured to discharge the toner accommodated in the first chamber to outside of the toner container, a filter configured to prevent passage of the toner and allow passage of air, a second chamber adjoining the first chamber via the filter, the second chamber including an intake port configured to take in air from the outside of the toner container, and a passage disposed in the first chamber and configured for the toner to pass through, the passage including a first opening opposed to a part of the filter with a gap and a second opening configured to communicate with the discharge port, the passage extending from the first opening to the second opening. The discharge port is configured to open in a direction intersecting an alignment direction in which the first chamber and the second chamber are aligned.

Further features of the present disclosure will become apparent from the following description of exemplary embodiments with reference to the attached drawings.

### BRIEF DESCRIPTION OF THE DRAWINGS

FIG. 1 is a sectional view of an image forming apparatus according to a first exemplary embodiment.

FIG. 2A is a perspective view of the image forming apparatus according to the first exemplary embodiment.

FIG. 2B is a perspective view of the image forming apparatus according to the first exemplary embodiment.

FIG. 2C is a perspective view of the image forming apparatus according to the first exemplary embodiment.

FIG. 3A is a perspective view of an image forming unit according to the first exemplary embodiment.

FIG. 3B is a perspective view of an image forming unit according to the first exemplary embodiment.

FIG. 4 is a perspective view of the image forming unit according to the first exemplary embodiment (with laser optical paths illustrated)

FIG. 5A is a top view of the image forming unit and a laser scanner unit according to the first exemplary embodiment.

FIG. 5B is a top view of the image forming unit and the laser scanner unit according to the first exemplary embodiment.

FIG. 6A is a sectional view of the image forming unit and the laser scanner unit according to the first exemplary embodiment, perpendicular to the rotation axes of drums.

FIG. 6B is a sectional view of the image forming unit and the laser scanner unit according to the first exemplary embodiment, perpendicular to the rotation axes of drums.

FIG. 7A is a perspective view of the image forming unit and the laser scanner unit according to the first exemplary embodiment, parallel to the rotation axes of the drums.

FIG. 7B is a perspective view of the image forming unit and the laser scanner unit according to the first exemplary embodiment, parallel to the rotation axes of the drums.

FIG. 8 is a perspective view of the image forming unit according to the first exemplary embodiment, pulled out of an apparatus main body.

FIG. 9A is a front view of a cartridge according to the first exemplary embodiment.

FIG. 9B is a top view of the cartridge according to the first exemplary embodiment.

FIG. 9C is a bottom view of the cartridge according to the first exemplary embodiment.

FIG. 9D is a side view of the cartridge according to the first exemplary embodiment.

FIG. 9E is a rear view of the cartridge according to the first exemplary embodiment.

FIG. 10A is a sectional view of the cartridge according to the first exemplary embodiment.

FIG. 10B is an exploded perspective view of the cartridge according to the first exemplary embodiment.

FIG. 10C is an exploded perspective view of the cartridge according to the first exemplary embodiment.

FIG. 11A is a sectional view of the cartridge according to the first exemplary embodiment.

FIG. 11B is an exploded perspective view of the cartridge according to the first exemplary embodiment.

FIG. 12A is a perspective view of an image forming unit according to a second exemplary embodiment.

FIG. 12B is a perspective view of the image forming unit according to the second exemplary embodiment.

FIG. 13 is a perspective view of the image forming unit according to the second exemplary embodiment (with LED optical paths illustrated)

FIG. 14 is a top view of the image forming unit according to the second exemplary embodiment.

FIG. 15 is a sectional view of the image forming unit according to the second exemplary embodiment, perpendicular to the rotation axes of drums.

FIG. 16 is a perspective view of the image forming unit according to the second exemplary embodiment.

FIG. 17A is a front view of a cartridge according to a first modification.

FIG. 17B is a top view of the cartridge according to the first modification.

FIG. 17C is a bottom view of the cartridge according to the first modification.

FIG. 17D is a side view of the cartridge according to the first modification.

FIG. 17E is a rear view of the cartridge according to the first modification.

### DESCRIPTION OF THE EMBODIMENTS

### First Exemplary Embodiment

### [Image Forming Apparatus]

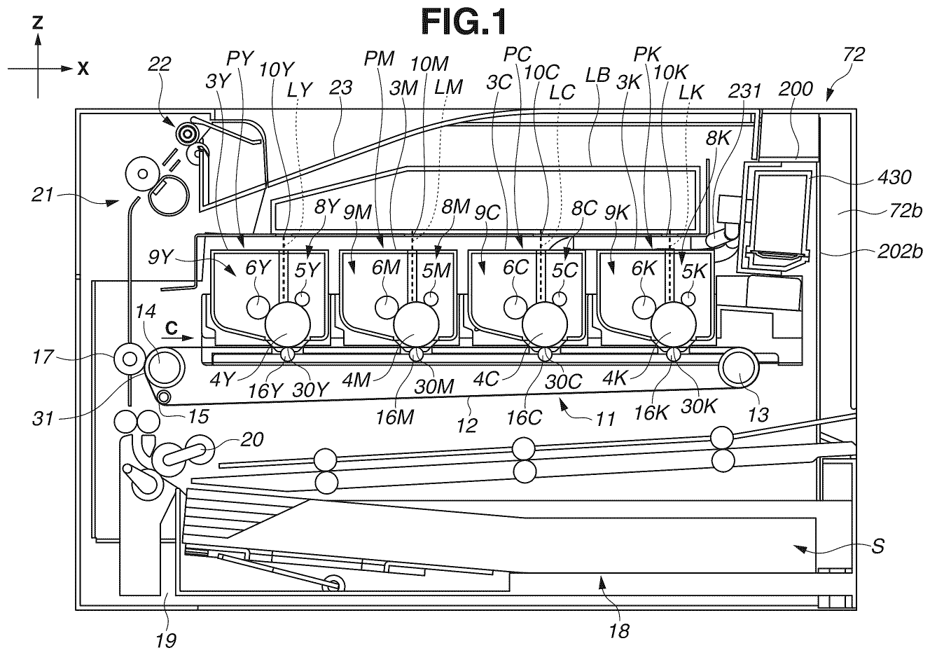

An image forming apparatus 1 according to a first exemplary embodiment of the present disclosure will be described with reference to FIG. 1. The electrophotographic image forming apparatus according to the present exemplary embodiment is a full-color image forming apparatus including four color process units. FIG. 1 illustrates a main cross section of the image forming apparatus 1.

The image forming apparatus 1 is a full-color laser printer using an electrophotographic process and can form full-color images on recording media S. The image forming apparatus 1 includes process units PY, PM, PC, and PK (hereinafter referred to as process units P) and an apparatus main body 72. The process units P are arranged in a first direction X and contain toners of respective different colors inside. The longitudinal direction of the process units P is a second direction Y perpendicular to the first direction. The process units PY, PM, PC, and PK will be referred to as a first process unit, a second process unit, a third process unit, and a fourth process unit, respectively.

Each process unit P includes an electrophotographic process element. To the process unit P, rotational driving force is transmitted from a driving output unit (not illustrated) of the apparatus main body 72, and a bias voltage (charging bias, developing bias, etc.) is supplied from a bias application unit (not illustrated) of the apparatus main body 72.

As illustrated in FIG. 1, the process units P include respective drum units 8Y, 8M, 8C, and 8K (hereinafter referred to as drum units 8). The drum units 8 include respective photosensitive drums 4Y, 4M, 4C, and 4K (hereinafter referred to as photosensitive drums 4) and charging rollers 5Y, 5M, 5C, and 5K (hereinafter referred to as charging rollers 5) serving as process means that act on the photosensitive drums 4. The photosensitive drums 4 are disposed with their rotation axes in the second direction Y. The photosensitive drums 4Y, 4M, 4C, and 4K will be referred to as a first photosensitive drum, a second photosensitive drum, a third photosensitive drum, and a fourth photosensitive drum, respectively.

The process units P include respective developing units 9Y, 9M, 9C, and 9K (hereinafter referred to as developing units 9) including developing rollers 6Y, 6M, 6C, and 6K (hereinafter referred to as developing rollers 6) that develop electrostatic latent images on the corresponding photosensitive drums 4. The developing units 9 are arranged in the first direction X. The developing rollers 6Y, 6M, 6C, and 6K will be referred to as a first developing roller, a second developing roller, a third developing roller, and a fourth developing roller, respectively. The developing units 9Y, 9M, 9C, and 9K will be referred to as a first developing unit, a second developing unit, a third developing unit, and a fourth developing unit, respectively.

The developing unit 9Y includes a developing container 3Y (first developing container) accommodating yellow (Y) toner (first toner), and is configured so that the yellow (Y) toner is supplied to the surface of the photosensitive drum 4Y by the developing roller 6Y that bears the yellow (Y) toner. The developing unit 9M includes a developing container 3M (second developing container) accommodating magenta (M) toner (second toner), and is configured so that the magenta (M) toner is supplied to the surface of the photosensitive drum 4M by the developing roller 6M that bears the magenta (M) toner. The developing unit 9C includes a developing container 3C (third developing container) accommodating cyan (C) toner (third toner), and is configured so that the cyan (C) toner is supplied to the surface of the photosensitive drum 4C by the developing roller 6C that bears the cyan (C) toner. The developing unit 9K includes a developing container 3K (fourth developing container) accommodating black (K) toner (fourth toner), and is configured so that the black (K) toner is supplied to the surface of the photosensitive drum 4K by the developing roller 6K that bears the black (K) toner. In a third direction Z intersecting both the first direction X and the second direction Y, a laser scanner unit LB (exposure unit) is located above the process units P (photosensitive drums 4). This laser scanner unit LB outputs laser light corresponding to image information. The third direction Z in the present exemplary embodiment is a direction along the gravitational direction.

The optical paths of laser light toward the photosensitive drums 4Y, 4M, 4C, and 4K will hereinafter be referred to as optical paths LY, LM, LC, and LK, respectively (hereinafter referred to as each optical path L or optical paths L). The laser light passes through exposure windows 10Y, 10M, 10C, and 10K of the laser scanner unit LB, and scans and exposes the surfaces of the respective photosensitive drums 4. Light-emitting diode (LED) exposure units may be used instead of the laser scanner unit LB.

An intermediate transfer belt unit 11 serving as a transfer member is located below the process units P in the third direction Z. This intermediate transfer belt unit 11 includes a driving roller 14, a tension roller 13, and an assist roller 15, across which a flexible transfer belt 12 is stretched.

Each photosensitive drum 4 contacts the upper surface of the transfer belt 12 at its lower surface. The contact portions between the respective photosensitive drums 4 and the transfer belt 12 are primary transfer portions 30Y, 30M, 30C, and 30K (hereinafter referred to as primary transfer portions 30). Primary transfer rollers 16Y, 16M, 16C, and 16K (hereinafter referred to as transfer rollers 16) are located inside the transfer belt 12 and opposed to the photosensitive drums 4.

A secondary transfer roller 17 is pressed against the driving roller 14 with the transfer belt 12 therebetween. The contact portion between the transfer belt 12 and the secondary transfer roller 17 is a secondary transfer portion 31.

A feed unit 18 is located below the intermediate transfer belt unit 11 in the third direction Z. The feed unit 18 includes a feed tray 19 where recording media S are stacked and accommodated, and a feed roller 20 that picks up a recording medium S from the feed tray 19 and conveys the recording medium S.

A fixing unit 21 that fixes toner images to the recording medium S and a discharge roller 22 that discharges the recording medium S to which the toner images are fixed to a discharge tray 23 are located in an upper part of the apparatus main body 72 in FIG. 1. The discharge roller 22 discharges the recording medium S in a direction along the first direction X. In the present exemplary embodiment, the downstream side in a discharge direction in which the recording medium S is discharged toward the discharge tray 23 by the discharge roller 22 will be referred to as the front side of the image forming apparatus 1, and the upstream side in the discharge direction as the rear side of the image forming apparatus 1.

### [Image Forming Operation]

An image forming operation for forming a full-color image will now be described. The photosensitive drums 4 are driven to rotate counterclockwise in FIG. 1 at a predetermined speed. The transfer belt 12 is driven to rotate forward (in the direction of the arrow C in FIG. 1) with respect to the rotation of the photosensitive drums 4 at a speed corresponding to the rotation speed of the photosensitive drums 4.

The laser scanner unit LB is driven as well. In the process units P, the charging rollers 5 uniformly charge the surfaces of the respective corresponding photosensitive drums 4 to a predetermined polarity and potential in synchronization with the driving of the laser scanner unit LB. The laser scanner unit LB scans and exposes the charged surfaces of the photosensitive drums 4 with laser light L based on image signals of the respective colors, whereby electrostatic latent images corresponding to the image signals of the respective colors are formed on the surfaces of the photosensitive drums 4. More specifically, the laser scanner unit LB exposes the photosensitive drum 4Y and the photosensitive drum 4M to form a first electrostatic latent image and a second electrostatic latent image on the photosensitive drum 4Y and the photosensitive drum 4M, respectively. Similarly, the laser scanner unit LB exposes the photosensitive drum 4C and the photosensitive drum 4K to form a third electrostatic latent image and a fourth electrostatic latent image on the photosensitive drum 4C and the photosensitive drum 4K, respectively.

The electrostatic latent images on the photosensitive drums 4 are developed through the supply of toner to the respective photosensitive drums 4 by the developing rollers 6 driven to rotate clockwise in FIG. 1 at the predetermined speed. By the electrophotographic image forming process described above, a yellow toner image is formed on the photosensitive drum 4Y of the process unit PY. The yellow toner image is then primarily transferred to the transfer belt 12. Similarly, a magenta toner image is formed on the photosensitive drum 4M of the process unit PM. The magenta toner image is then primarily transferred to the transfer belt 12 to be superposed on the yellow toner image on the transfer belt 12. A cyan toner image is formed on the photosensitive drum 4C of the process unit PC. The cyan toner image is then primarily transferred to the transfer belt 12 to be superposed on the yellow and magenta toner images on the transfer belt 12. A black toner image is formed on the photosensitive drum 4K of the process unit PK. The black toner image is then primarily transferred to the transfer belt 12 to be superposed on the yellow, magenta, and cyan toner images on the transfer belt 12.

In such a manner, the yellow, magenta, cyan, and black, four-color full-color unfixed toner images are formed on the transfer belt 12. Meanwhile, the recording media S are separated one by one and fed from the feed tray 19 by the feed roller 20 at predetermined control timing. The recording medium S is guided into the secondary transfer portion 31 that is the contact portion between the secondary transfer roller 17 and the transfer belt 12 at predetermined control timing. In the process of the recording medium S being conveyed through the secondary transfer portion 31, the superposed four-color toner images on the transfer belt 12 are transferred to the recording medium S. The recording medium S to which the toner images are transferred is heated and pressurized in the fixing unit 21, whereby the toner images are fixed to the recording medium S. The recording medium S to which the toner images are fixed is discharged to the discharge tray 23 by the discharge roller 22.

The image forming apparatus 1 includes cartridges 430Y, 430M, 430C, and 430K (hereinafter, cartridges 430) that can be detachably attached to the apparatus main body 72. The cartridges 430 are arranged in the second direction Y. In other words, the cartridges 430 are arranged in a direction intersecting (orthogonal to) the direction in which the developing units 9 are arranged. The cartridges 430Y, 430M, 430C, and 430K will be referred to as a first cartridge (first toner container), a second cartridge (second toner container), a third cartridge (third toner container), and a fourth cartridge (fourth toner container), respectively.

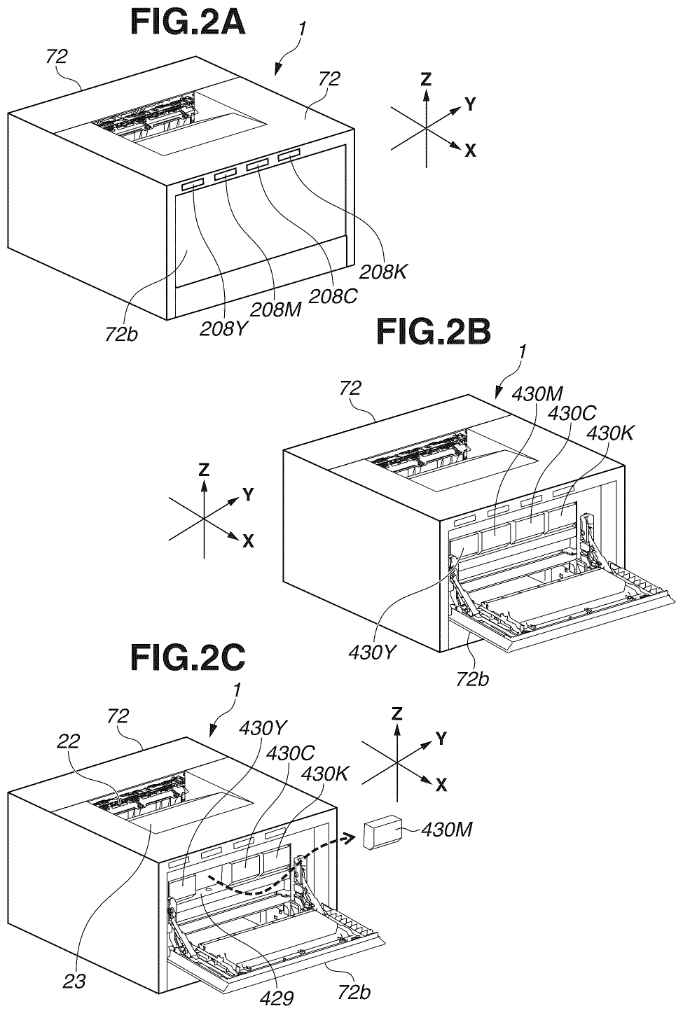

FIG. 2A is a perspective view of the image forming apparatus 1 with a front door 72b closed. FIG. 2B is a perspective view of the image forming apparatus 1 with the front door 72b open. FIG. 2C is a perspective view of the image forming apparatus 1 with the front door 72b open and the cartridge 430M taken out of a cartridge holder 429.

The cartridges 430 are attached to the front upper part of the apparatus main body 72 so that the cartridges 430 can be accessed by opening the front door 72b. In other words, the cartridges 430 are located at the downstream end of the apparatus main body 72 in the discharge direction of the discharge roller 22. The front door 72b is configured to be movable between a closed position where the front opening of the apparatus main body 72 is closed (see FIG. 2A) and an open position where the opening is open (see FIG. 2B). With the front door 72b moved to the open position, as illustrated in FIG. 2B, the cartridges 430 are exposed to the outside of the image forming apparatus 1 via the opening. The cartridges 430 are arranged in the second direction Y, and configured to be detachably attachable to the apparatus main body 72 in the first direction X as illustrated in FIG. 2C. The process units P can thus be replenished with toner without detaching the process units P from the apparatus main body 72.

Since the cartridges 430 are disposed on the front side of the image forming apparatus 1, the cartridges 430 can be accessed from the front side as with collecting the recording media S discharged to the discharge tray 23. The configuration where the cartridge holder 429 is disposed on the front side of the image forming apparatus 1 prevents the process units P from being exposed even after the cartridges 430 are detached (see FIG. 2C). With the front door 72b closed, the cartridges 430 are accommodated inside the apparatus main body 72.

As illustrated in FIG. 2A, indicators 208Y, 208M, 208C, and 208K (hereinafter referred to as indicators 208) (indication units, display units) of the respective colors are disposed on the front of the image forming apparatus 1. The indicators 208 are arranged in the second direction Y to correspond to the respective cartridges 430. The indicator 208Y (first indicator) is in yellow, the indicator 208M (second indicator) in magenta, the indicator 208C (third indicator) in cyan, and the indicator 208K (fourth indicator) in black. The indicators 208 include LEDs or labels of the colors corresponding to the toner colors of the respective cartridges, and are provided to prevent incorrect installation of the cartridges 430. The indicators 208 may have a remaining toner level display function for the corresponding process units P (developing units 9).

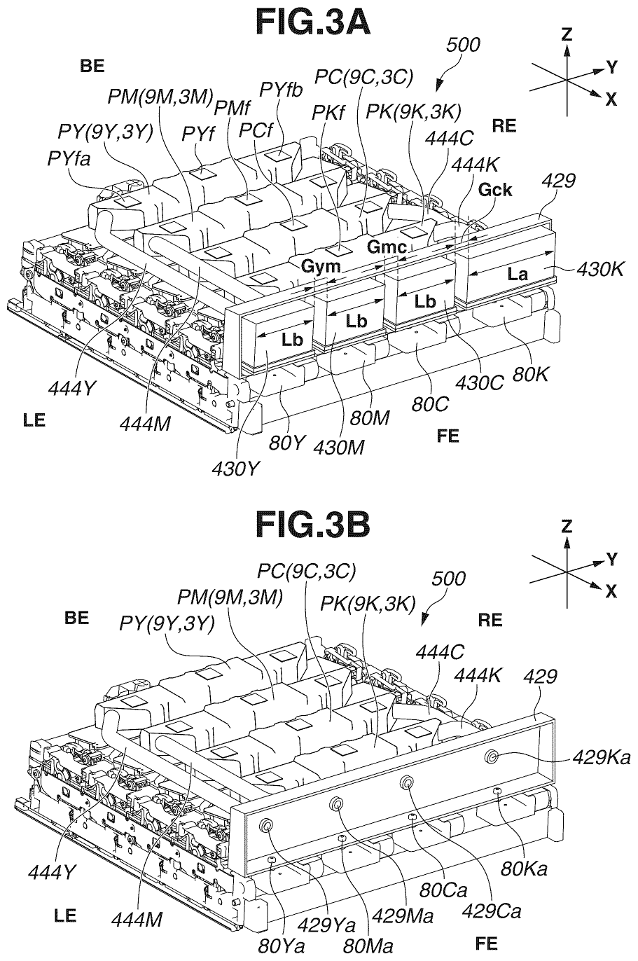

A toner conveyance mechanism from the cartridges 430 to the respective corresponding process units P will be described with reference to FIGS. 3A to 7B.

A unit including the cartridges 430, the process units P, and conveyance paths for conveying toner from the cartridges 430 to the respective process units P to be described below will be referred to as an image forming unit 500.

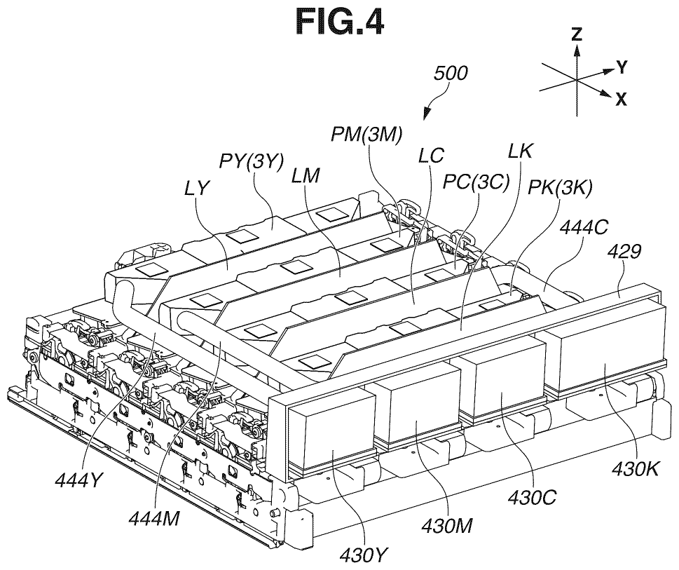

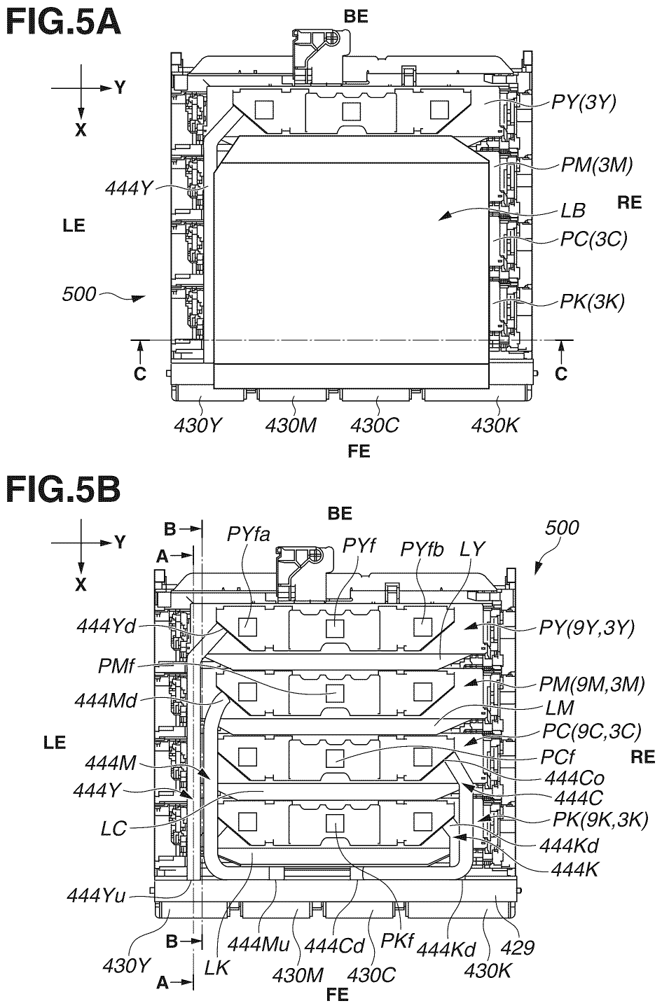

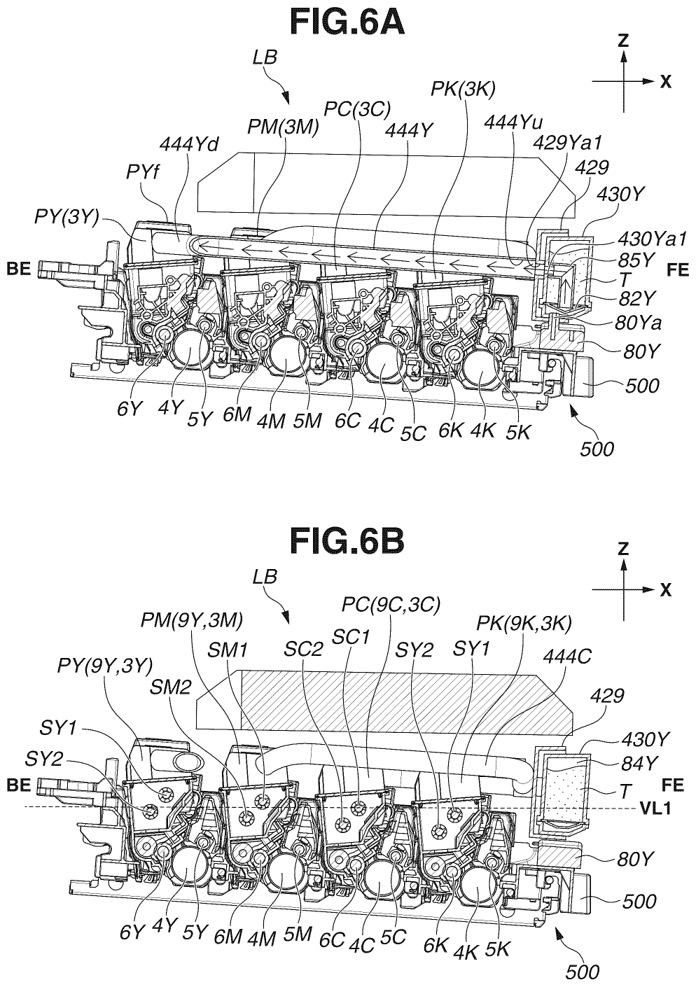

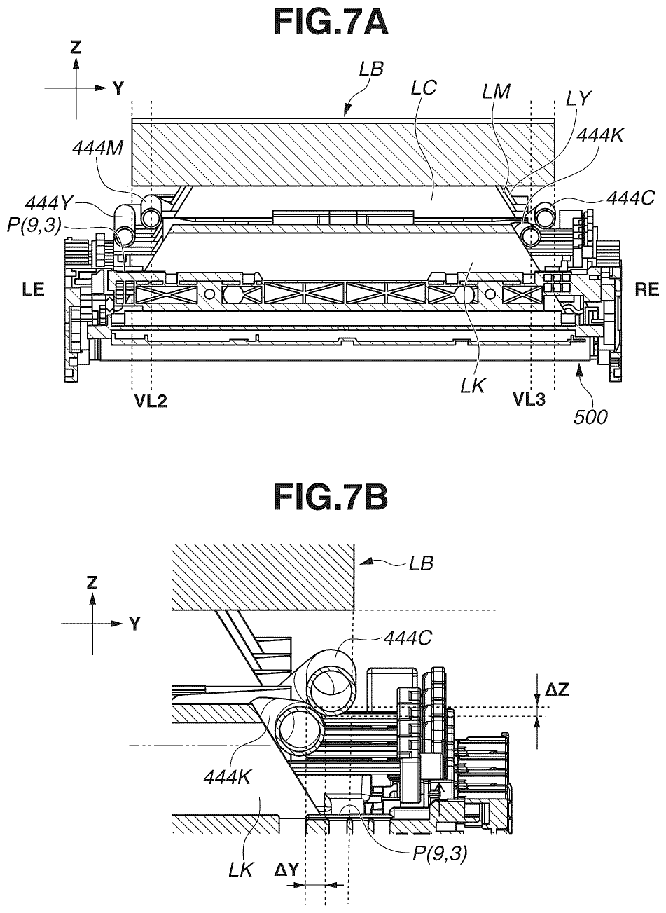

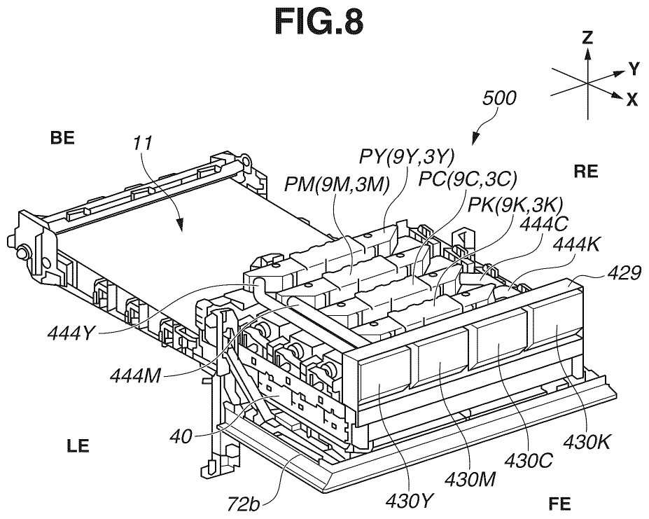

FIG. 3A is a perspective view of the image forming unit 500 with the cartridges 430 attached. FIG. 3B is a perspective view of the image forming unit with the cartridges 430 detached. FIG. 4 is a perspective view of the image forming unit 500, with the optical paths of laser light from the laser scanner unit LB illustrated. FIG. 5A is a top view of the laser scanner unit LB and the image forming unit 500. FIG. 5B is a top view of the image forming unit 500. FIGS. 6A and 6B are sectional views taken along line A-A and line B-B of FIG. 5B, respectively. FIG. 7A is a sectional view taken along line C-C of FIG. 5A.

As illustrated in FIGS. 3A and 4, pump units 80Y, 80M, 80C, and 80K (hereinafter referred to as pump units 80) are located below the cartridge holder 429. The pump units 80 are arranged in the second direction Y. The pump units 80Y, 80M, 80C, and 80K will be referred to as a first pump unit (first pump), a second pump unit (second pump), a third pump unit (third pump), and a fourth pump unit (fourth pump), respectively. Positive displacement pumps such as reciprocating pumps and rotary pumps are used for the pump units 80. Reciprocating pumps are pumps that perform suction and discharge through the reciprocating motion of pistons, plungers, etc. Examples include piston pumps, plunger pumps, and diaphragm pumps. Rotary pumps are pumps that perform suction and discharge through the rotary motion of gears, rotors, etc. Examples include gear pumps, screw pumps, and bane pumps. In the present exemplary embodiment, diaphragm pumps are used. The four pump units (pumps) may be configured as a single pump unit. In the present exemplary embodiment, the pump units 80 are disposed on the apparatus main body 72, but may be disposed on the cartridges 430.

As illustrated in FIGS. 3B and 6A, openings that expose discharge ports 80Ya, 80Ma, 80Ca, and 80Ka (hereinafter referred to as discharge ports 80a) for discharging air generated (sent out) by the respective pump units 80 are formed in the portion of the cartridge holder 429 opposed to the lower surfaces of the cartridges 430. The discharge ports 80a open upward.

The air discharged upward from the discharge ports 80a is supplied to the interior of the respective cartridges 430 attached to the cartridge holder 429. The air supplied to the interior of the cartridges 430 is discharged from the cartridges 430 along with the toners. The internal structure of the cartridges 430 will be described below, and details thereof are thus omitted here.

The toners discharged from the cartridges 430 with the air are received by replenishment pipes 444Y, 444M, 444C and 444K (hereinafter referred to as replenishment pipes 444) via receiving ports 429Ya, 429Ma, 429Ca, and 429Ka (hereinafter referred to as receiving ports 429) formed in the cartridge holder 429, illustrated in FIG. 3B. The replenishment pipes 444 extend to and are connected to the respective developing units 9. The receiving ports 429a are through holes formed through the surface of the cartridge holder 429 opposed to the rear surfaces of the cartridges 430. The receiving ports 429a open in the first direction X that is the direction in which the developing units 9 are arranged. The direction in which the receiving ports 429a open intersects the direction in which the discharge ports 80a open.

As illustrated in FIG. 5B, on the rear side of the portion of the cartridge holder 429 where the receiving ports 429a are formed, upstream ends 444Yu, 444Mu, 444Cu, and 444Ku (hereinafter referred to as upstream ends 444u) of the replenishment pipes 444 are connected to the cartridge holder 429 to communicate with the respective receiving ports 429a.

The toners received via the receiving ports 429a are moved through the replenishment pipes 444 from the upstream ends 444u to downstream ends 444Yd, 444Md, 444Cd, and 444Kd (hereinafter referred to as downstream ends 444d) by the air supplied from the respective cartridges 430, and replenish the developing units 9.

The downstream ends 444d of the replenishment pipes 444 are connected the ends of the respective developing units 9 in the second direction Y. Specifically, the downstream end 444Yd of the replenishment pipe 444Y and the downstream end 444Md of the replenishment pipe 444M are connected to the end of the developing unit 9Y on an LE side and the end of the developing unit 9M on the LE side, respectively. The downstream end 444Cd of the replenishment pipe 444C and the downstream end 444Kd of the replenishment pipe 444K are connected to the end of the developing unit 9C on a RE side and the end of the developing unit 9K on the RE side, respectively. The reason is to reduce the lengths of the replenishment pipes 444 for reduced pressure loss. As a result, small pumps can be selected for the pump units 80, whereby the image forming unit 500 can be miniaturized.

Next, the arrangement of the cartridge 430Y will be described. As illustrated in FIG. 6B, the cartridge 430Y and the process units P (developing units 9) are arranged on an imaginary line VL1 extending in the first direction X. That is, the cartridge 430Y is arranged in line with the developing units 9 in the first direction X. In other words, as viewed in the first direction X, at least a part of the cartridge 430Y is located to overlap the developing units 9. The cartridges 430M, 430C, and 430K are also arranged in line with the developing units 9 in the first direction X. In other words, as viewed in the first direction X, at least a part of each of the cartridges 430M, 430C, and 430K is arranged to overlap the developing units 9. Such arrangement of the cartridges 430 can reduce the height of the image forming apparatus 1 in the third direction Z, whereby the image forming apparatus 1 can be miniaturized. The cartridges 430 may be located above the process units (developing units 9) in the third direction Z.

Next, the layout of the replenishment pipes 444 will be described. In FIGS. 4, 5B, 7A, and 7B, the optical paths of the laser light from the laser scanner unit LB are visualized for the sake of convenience. The optical paths LY, LM, LC, and LK (hereinafter referred to as optical paths L) are the optical paths of the laser light emitted from the laser scanner unit LB toward the photosensitive drums 4Y, 4M, 4C, and 4K, respectively.

The replenishment pipes 444 are laid out to not interfere with the optical paths L. Specifically, as illustrated in FIGS. 5B and 7A, the replenishment pipes 444Y and 444M are disposed on the LE-side ends of the process units P in the second direction Y to avoid the optical paths L. The replenishment pipe 444Y is located outside, i.e., on the LE side of the replenishment pipe 444M in the first direction X.

As illustrated in FIG. 5A, at least a part of the replenishment pipe 444Y does not overlap the laser scanner unit LB when viewed from above in the third direction Z. As illustrated in FIG. 5A, the replenishment pipe 444M overlaps the laser scanner unit LB when viewed from above in the third direction Z.

As illustrated in FIG. 7A, the replenishment pipe 444Y and the replenishment pipe 444M are located below the laser scanner unit LB and above the process units P (developing units 9) in the third direction Z. In other words, the replenishment pipes 444Y and 444M are located between the laser scanner unit LB and the process units P in the third direction Z. The optical paths L widen in the second direction Y as they approach the process units P (photosensitive drums 4) from the laser scanner unit LB. This leaves a space between the optical path LK and the laser scanner unit LB in the third direction Z. The replenishment pipe 444M is located in the space between the optical path LK and the laser scanner unit LB in the third direction Z. More specifically, as illustrated in FIG. 7A, the laser scanner unit LB, the replenishment pipe 444M, and the optical path LK, when viewed in the first direction X, fall on an imaginary line VL2 extending in the third direction Z.

Next, as illustrated in FIGS. 5B, 7A, and 7B, the replenishment pipes 444C and 444K are disposed on the RE-side ends of the process units P in the second direction Y to avoid the optical paths L. In other words, the replenishment pipes 444C and 444K are located at the ends opposite to those where the replenishment pipes 444Y and 444M are in the second direction Y. The replenishment pipe 444C is located outside, i.e., on the RE side of the replenishment pipe 444K in the second direction Y.

As illustrated in FIG. 5A, the replenishment pipes 444C and 444K both overlap the laser scanner unit LB as viewed from above in the third direction Z. As illustrated in FIG. 7B, the replenishment pipes 444C and 444K are located below the laser scanner unit LB and above the process units P (developing units 9). In other words, the replenishment pipes 444C and 444K are located between the laser scanner unit LB and the process units P in the third direction Z. The replenishment pipe 444K is located in a space between the optical path LK and the laser scanner unit LB in the third direction Z. More specifically, as illustrated in FIG. 7A, the laser scanner unit LB, the replenishment pipe 444K, and the optical path LK, when viewed in the first direction X, fall on an imaginary line VL3 extending in the third direction Z.

As illustrated in FIG. 7B, the replenishment pipe 444C is located above the replenishment pipe 444K. As viewed in the third direction Z, the replenishment pipe 444C overlaps the replenishment pipe 444K by ΔY. As viewed in the second direction Y, the replenishment pipe 444C overlaps the replenishment pipe 444K by ΔZ.

The foregoing layout of the replenishment pipes 444 enables miniaturization of the image forming unit 500 in the second direction Y or the third direction Z. Note that the replenishment pipes do not necessarily need to be laid out as described above.

The image forming unit 500 is desirably configured to enable easy access to the process units P and the replenishment pipes 444 for the purpose of maintenance and replacement of the process units P, the replenishment pipes 444, and the like during failure servicing etc. In the exemplary embodiment, the image forming unit 500 is thus configured so that it can be pulled out from a BE side (rear side) to an FE side (front side) relative to the apparatus main body 72 (intermediate transfer belt unit 11). However, the image forming apparatus 1 may be configured so that the image forming unit 500 is unable to be pulled out.

### [Cartridge Structure]

The structure of the cartridges 430 (toner containers) according to the present exemplary embodiment will be described with reference to FIGS. 3A and 9A to 11B.

As illustrated in FIG. 3A, a width La of the cartridge 430K in the second direction Y is greater than a width Lb of the cartridge 430Y, the cartridge 430M, and the cartridge 430C (hereinafter referred to as cartridges 430Y to 430C). The cartridge 430K thus has a toner-accommodating capacity greater than that of the cartridges 430Y to 430C. The configuration that can accommodate black toner, which is typically consumed in larger quantities than the other color toners, makes the numbers of times of replacement of the cartridges 430Y, 430M, 430C, and 430K more likely to be equalized. Since the cartridges 430 have the same structure except for the width in the second direction Y, the structure of the cartridge 430Y will now be described and a description of the structures of the cartridges 430Y to 430K will be omitted.

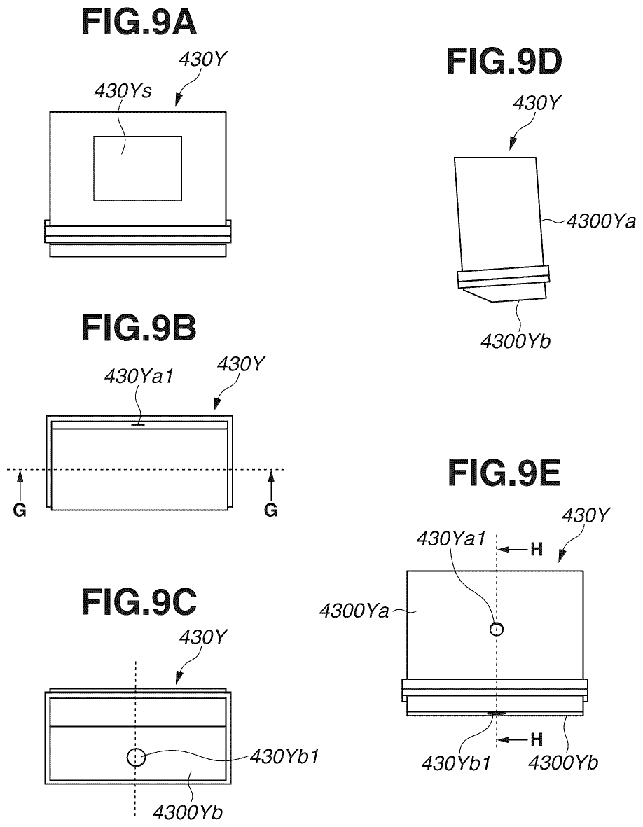

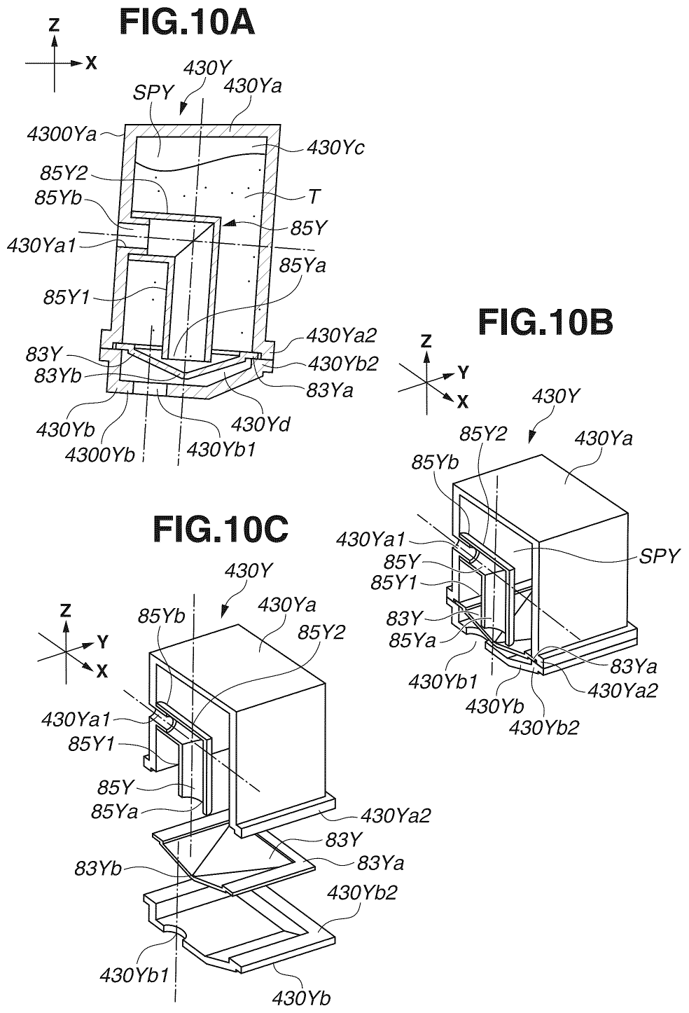

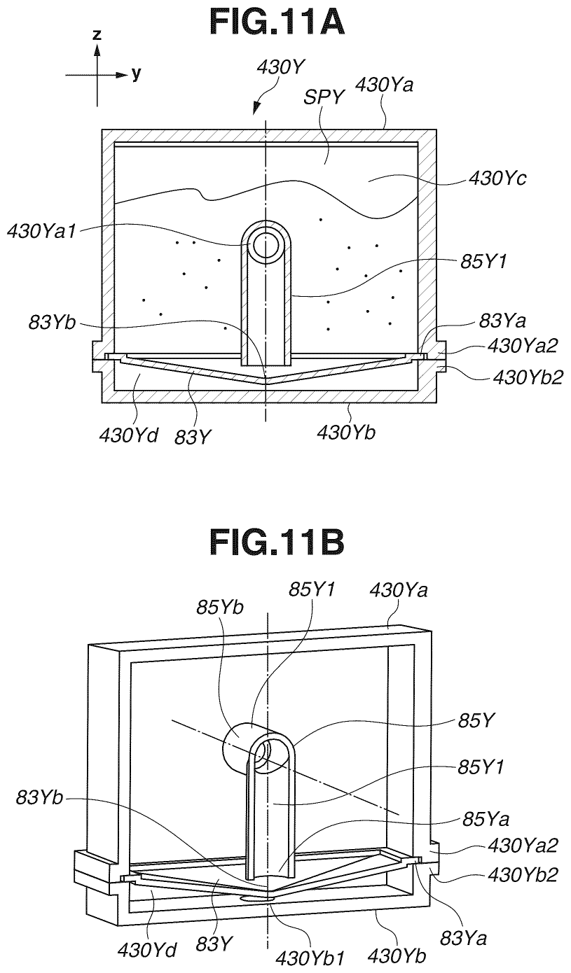

FIGS. 9A, 9B, 9C, 9D, and 9E are a front view, top view, bottom view, right side view, and rear view of the cartridge 430Y, respectively. FIG. 10A is a sectional view taken along line H-H of FIG. 9E. FIG. 10B is a perspective view of the cartridge 430Y. FIG. 10C is an exploded perspective view of the cartridge 430Y. FIG. 11A is a sectional view taken along line G-G of FIG. 9B. FIG. 11B is a perspective view of FIG. 11A. The following description of the structure of the cartridge 430Y applies to a state (posture) where the cartridge 430Y is attached to the cartridge holder 429.

As illustrated in FIGS. 10A to 10C, the cartridge 430Y includes a first frame 430Ya, a second frame 430Yb, a filter 83Y (first filter, first air-passing member), and a discharge duct 85Y (first discharge duct, first passage, first flow path). Although not illustrated in the drawings, the cartridge 430M similarly includes a third frame 430Ma, a fourth frame 430Mb, a filter 83M (second filter, second air-passing member), and a discharge duct 85M (second discharge duct, second passage, second flow path). Similarly, the cartridge 430C includes a fifth frame 430Ca, a sixth frame 430Cb, a filter 83C (third filter, third air-passing member), and a discharge duct 85C (third discharge duct, third passage, third flow path). Similarly, the cartridge 430K includes a seventh frame 430Ka, an eighth frame 430Kb, a filter 83K (fourth filter, fourth air-passing member), and a discharge duct 85K (fourth discharge duct, fourth passage, fourth flow path).

The first frame 430Ya and the second frame 430Yb of the present exemplary embodiment are resin-molded members, but may be made of paper or the like. As illustrated in FIG. 9E, a discharge port 430Ya1 (first discharge port, first hole) is formed in a rear surface 4300Ya of the first frame 430Ya. As illustrated in FIG. 9C, a receiving port 430Yb1 (first receiving port, first intake port, second hole) is formed in a bottom surface 4300Yb of the second frame 430Yb. The discharge port 430Ya1 and the receiving port 430Yb1 are desirably formed in surfaces of the cartridge 430Y other than those intersecting the second direction Y in which the cartridges 430 are arranged (those facing in the second direction Y). This can reduce gaps G (Gym, Gmc, and Gck) between the cartridges 430 illustrated in FIG. 3A. As a result, the widths L of the cartridges 430 can be increased to increase the toner-accommodating capacities. The gap Gym refers to the gap between the cartridges 430Y and 430M in the second direction Y. The gap Gmc refers to the gap between the cartridges 430M and 430C in the second direction Y. The gap Gck refers to the gap between the cartridges 430C and 430K in the second direction Y.

The discharge port 430Ya1 is formed in the rear surface 4300Ya of the cartridge 430Y (downstream end surface of the cartridge 430Y in the attachment direction) to open downstream in the attachment direction. This facilitates engaging the discharge port 430Ya1 with the receiving port 429Ya of the cartridge holder 429 for communication in attaching the cartridge 430Y to the cartridge holder 429. The discharge port 430Ya1 may be formed in the bottom surface 4300Yb or the top surface of the cartridge 430Y, and the receiving port 430Yb1 may be formed in the rear surface 4300Ya or the top surface. If there is sufficient space within the apparatus main body 72, the discharge port 430Ya1 and the receiving port 430Yb may be formed in the surfaces intersecting the second direction Y. Although not illustrated in the drawings, the cartridge 430M has a discharge port 430Ma1 (second discharge port) and a receiving port 430Mb1 (second receiving port, second intake port) in an arrangement similar to that of the cartridge 430Y. The cartridge 430C has a discharge port 430Ca1 (third discharge port) and a receiving port 430Cb1 (third receiving port, third intake port) in an arrangement similar to that of the cartridge 430Y. The cartridge 430K has a discharge port 430Ka1 (fourth discharge port) and a receiving port 430Kb1 (fourth receiving port, fourth intake port) in an arrangement similar to that of the cartridge 430Y.

A not-illustrated sealing member (seal or shutter) may be disposed on the discharge port 430Ya1. In a state where the cartridge 430Y is not attached to the cartridge holder 429 of the apparatus main body 72, the sealing member seals the discharge port 430Ya1 to prevent toner T accommodated inside from leaking out of the cartridge 430Y. When the cartridge 430Y is attached to the cartridge holder 429, the sealing member is removed, displaced, or otherwise operated to open the discharge port 430Ya1.

A label 430Ys on the front of the cartridge 430Y illustrated in FIG. 9A indicates the color of the toner inside. A label 430Ys may illustrate instructions how to attach the cartridge 430Y to the cartridge holder 429, or display information about the cartridge 430Y.

The first frame 430Ya and the second frame 430Yb include a flange portion 430Ya2 and a flange portion 430Yb2, respectively. The flange portion 430Ya2 and the flange portion 430Yb2 are welded to each other by ultrasonic welding, whereby an internal space SPY of the cartridge 430Y illustrated in FIG. 10A is formed. The flange portion 430Ya2 and the flange portion 430Yb2 may be fixed to each other with adhesive or screws.

The filter 83Y is disposed to partition (divide) the internal space SPY of the cartridge 430Y into two, a toner chamber 430Yc (first chamber) and an air chamber 430Yd (second chamber). In other words, the air chamber 430Yd adjoins the toner chamber 430Yc via the filter 83Y. Although not illustrated in the drawings, the filter 83M is disposed to partition (divide) an internal space SPM of the cartridge 430M into two, a toner chamber 430Mc (third chamber) and an air chamber 430Md (fourth chamber). In other words, the air chamber 430Md adjoins the toner chamber 430Mc via the filter 83M. The filter 83C is disposed to partition (divide) an internal space SPC of the cartridge 430C into two, a toner chamber 430Cc (fifth chamber) and an air chamber 430Cd (sixth chamber). In other words, the air chamber 430Cd adjoins the toner chamber 430Cc via the filter 83C. The filter 83K is disposed to partition (divide) an internal space SPK of the cartridge 430K into two, a toner chamber 430Kc (seventh chamber) and an air chamber 430Kd (eighth chamber). In other words, the air chamber 430Kd adjoins the toner chamber 430Kc via the filter 83K.

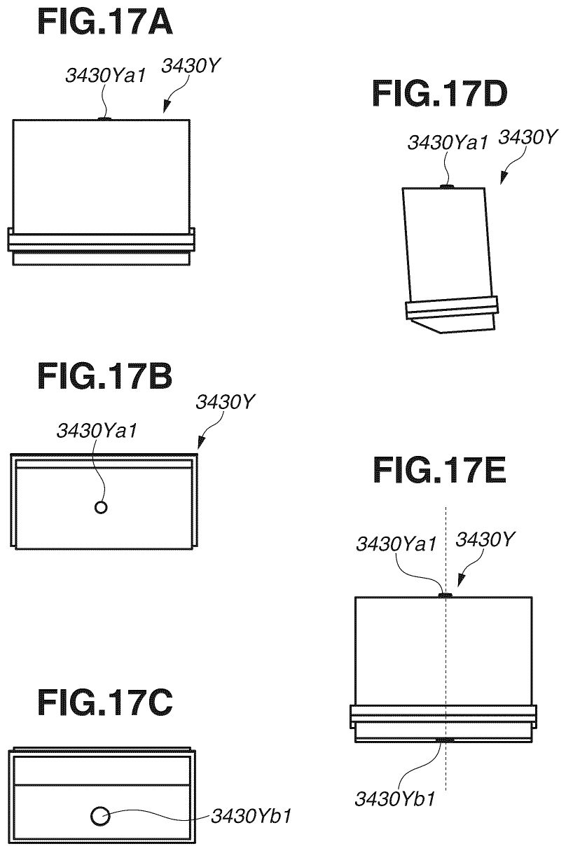

The toner chamber 430Yc is located above the air chamber 430Yd, and is aligned with the air chamber 430Yd in the third direction Z. In other words, the attachment posture of the cartridge 430Y relative to the apparatus main body 72 is oriented such that the toner chamber 430Yc is located above the air chamber 430Yd. The alignment direction of the toner chamber 430Yc and the air chamber 430Yd is the third direction Z. In the present exemplary embodiment, the receiving port 430Yb1 thus opens in this alignment direction, and the discharge port 430Ya1 opens in a direction intersecting the alignment direction. FIGS. 17A, 17B, 17C, 17D, and 17E are a front view, top view, bottom view, side view, and rear view of a cartridge 3430Y according to a modification, respectively. As described above, the discharge port 430Ya1 may open in the alignment direction (third direction Z) in which the toner chamber 430Yc and the air chamber 430Yd are aligned with each other, as illustrated in FIGS. 17A to 17E. As illustrated in FIG. 17B, a discharge port 3430Ya1 may be formed in the top surface. In this modification, as illustrated in FIG. 17C, an intake port 3430Yb1 is located in the bottom surface, so that both the intake port 3430Yb1 and the discharge port 3430Ya1 open in the alignment direction (third direction Z). In other words, the discharge port 3430Ya1 is formed in the surface opposite to the surface of the cartridge 3430Y where the intake port 3430Yb1 is formed in the alignment direction. This provides the effect of facilitating design such that the pressure loss in the air flow path within the cartridge 3430Y is smaller than that of the cartridge 430 according to the first exemplary embodiment.

The toner chamber 430Yc is configured to accommodate the toner T. In the toner chamber 430Yc, the toner T is supported by the filter 83Y.

The air chamber 430Yd does not accommodate any toner. The filter 83Y includes a porous member made of resin fibers, for example, and has pore size and density that allow passage of air and prevent passage of toner. In other words, the filter 83Y is configured to allow the passage of air and prevent the passage of toner. As illustrated in FIGS. 10A to 10C, 11A, and 11B, the filter 83Y is held by the first frame 430Ya and the second frame 430Yb with its outer edge portion 83Ya sandwiched between the flange portion 430Ya2 of the first frame 430Ya and the flange portion 430Yb2 of the second frame 430Yb. The filter 83Y slopes from the outer edge portion 83Ya toward a lowermost portion 83Yb located below the outer edge portion 83Ya. In other words, the filter 83Y includes portions (sloping portions) that decline as they extend toward (approach) the lowermost portion 83Yb in the first direction X, the second direction Y, or a horizontal direction.

The lowermost portion 83Yb protrudes from the outer edge portion 83Ya in a direction from the toner chamber 430Yc toward the air chamber 430Yd. As illustrated in FIGS. 10A and 11B, the lowermost portion 83Yb is located at the center of the filter 83Y in the first direction Y and the second direction Y. A filter molded in such a shape is used as the filter 83Y.

The toner chamber 430Yc includes the discharge duct 85Y (passage). The discharge duct 85Y according to the present exemplary embodiment is a resin-molded member, but may be made of paper, rubber, or the like. The discharge duct 85Y is a duct that has an inlet 85Ya (first opening) and an outlet 85Yb (second opening) and extends from the inlet 85Ya to the outlet 85Yb. The discharge duct 85Y is a passage through which the toner T accommodated in the toner chamber 430Yc passes when being moved toward the discharge port 430Ya1. The discharge duct 85Y includes a first portion 85Y1 where the inlet 85Ya is formed and that extends in the third direction Z, and a second portion 85Y2 where the outlet 85Yb is formed and that extends in the first direction X.

The direction in which the first portion 85Y1 extends and the direction in which the second portion 85Y2 extends intersect (are orthogonal). The outlet 85Yb of the discharge duct 85Y is connected to the discharge port 430Ya1 for communication. The inlet 85Ya of the discharge duct 85Y is opposed to the lowermost portion 83Yb, which is a part of the filter 83Y, with a gap therebetween. The inlet 85Ya is desirably close to the filter 83Y. When the remaining level of the toner T in the toner chamber 430Yc becomes low, the toner T fluidized by the air received through the receiving port 430Yb1 moves along the slopes of the filter 83Y described above and collects to the lowermost portion 83Yb. The inlet 85Ya of the discharge duct 85Y can guide the toner T collecting to the lowermost portion 83Yb of the filter 83Y to the discharge port 430Ya1. The toner T can thus be efficiently discharged to the outside of the cartridge 430Y even when the remaining level of the toner accommodated in the toner chamber 430Yc of the cartridge 430Y is low.

The cartridges according to the present exemplary embodiment are configured to discharge toner to the outside of the cartridges using air, and do not need to include rotary members such as screws. Cartridges of simple structure with low parts count can thus be obtained.

### [Toner Conveyance Mechanism]

The mechanism for conveying the toner accommodated in the toner chamber 430Yc of the cartridge 430Y to the developing unit 9Y will be described.

As illustrated in FIG. 6A, the air discharged upward from the discharge port 80Ya of the pump unit 80Y is received at the air chamber 430Yd through the receiving port 430Yb1 of the cartridge 430Y. The air then increases the air pressure of the air chamber 430Yd, passes through the filter 83Y, and flows into the toner chamber 430Yc. The air flowed into the toner chamber 430Yc enters between the particles of the toner T and fluidizes the toner T. The toner T mixed with the air and fluidized is moved through the discharge duct 85Y from the inlet 85Ya to the outlet 85Yb by the air received at the air chamber 430Yd via the receiving port 430Yb1, and discharged to the outside of the cartridge 430Y through the discharge port 430Ya1.

In the present exemplary embodiment, the air chamber 430Yd that is a hermetic space is provided between the discharge port 80Ya and the filter 83Y. This efficiently directs the air discharged from the discharge port 80Ya toward the filter 83Y without dispersion outside the cartridge 430Y. For example, in situations where the toner T in the toner chamber 430Yc agglomerates, such as when the cartridge 430Y is subjected to vibration or left standing for a long period of time, the pressure needed to flow the air into the toner cartridge 430Yc through the filter 83Y is high. Even in such cases, the air can be sent into the toner chamber 430Yc through the filter 83Y by continuing sending the air from the pump unit 80Y to the air chamber 430Yd to increase the pressure (air pressure) in the air chamber 430Yd. With the provision of the air chamber 430Yd, it is sufficient for the pump unit 80Y to have performance capable of producing pressure at which the air can continue to be sent into the air chamber 430Yd until the pressure needed for the air to pass through the filter 83Y into the toner chamber 430Yc is reached. Since there is no particular requirement for the discharge speed or discharge flow rate, a small-sized pump unit can be employed, which can contribute to miniaturization of the apparatus.

As illustrated in FIG. 6A, the toner T discharged from the discharge port 430Ya1 of the cartridge 430Y enters the interior of the replenishment pipe 444Y from the upstream end 444Yu via the receiving port 429Ya of the cartridge holder 429. The toner T that has entered the interior of the replenishment pipe 444Y from the upstream end 444Yu is moved to the downstream end 444Yd by the air that, like the toner T, has been discharged from the discharge port 430Ya1 of the cartridge 430Y and flowed into the upstream end 444Yu, and replenishes the developing unit 9Y (developing container 3Y) of the process unit PY.

The toner replenished into the developing unit 9Y (developing container 3Y) from the end of the developing unit 9Y in the second direction Y is agitated and evened out by agitation members SY1 and SY2 illustrated in FIG. 6B. The agitation members SY1 and SY2 may be screws configured to convey the toner from the end of the developing unit 9Y where the downstream end 444Yd of the replenishment pipe 444Y is connected to the opposite end of the developing unit 9Y in the second direction Y.

Since not only the toner T but also the air flows from the replenishment pipe 444Y into the developing unit 9Y (developing container 3Y), the internal pressure of the developing unit 9Y can increase easily. In the present exemplary embodiment, as illustrated in FIGS. 3A, 3B, and 5B, an exhaust filter unit PYf is therefore disposed on the top surface of the developing unit 9Y. The exhaust filter unit PYf refers to the portion where a through hole is formed in the frame constituting the developing unit 9Y and a filter made of unwoven fabric or the like is disposed over the through hole. The toner T flowing from the replenishment pipe 444Y into the developing unit 9Y remains in the developing unit 9Y while at least part of the air is discharged out of the developing unit 9Y through the discharge filter unit PYf. This suppresses the increase in the internal pressure of the developing unit 9Y, facilitating the flow of the toner T and the air from the cartridge 430Y into the developing unit 9Y via the replenishment pipe 444Y.

In the present exemplary embodiment, the exhaust filter unit PYf is located in the center of the developing unit 9Y in the second direction Y. Like an exhaust filter PFYa, the exhaust filter unit PYf may be located at the end of the developing container 3Y where the upstream end 444YU of the replenishment pipe 444Y is located in the second direction Y. Like an exhaust filter PFYb, the exhaust filter unit PYf may be located at the end of the developing unit 9Y opposite to the end where the upstream end 444Yu of the replenishment pipe 444Y is located in the second direction Y. Exhaust filters may be disposed on the side surfaces of the developing unit 9Y instead of the top surface.

In configurations where the conveyance paths change their directions halfway or where the conveyance paths differ color by color like the replenishment pipes 444 according to the present exemplary embodiment, air is desirably employed as means of conveyance for conveying toner. This improves the design flexibility of the conveyance paths compared to adopting screws or the like as the conveyance means, and can reduce the parts count since conveyance members are not needed.

### Second Exemplary Embodiment

As a second exemplary embodiment, a configuration where light L′ from LED units is used as means for forming electrostatic latent images on the photosensitive drums 4 instead of the laser light L from the laser scanner unit LB will be described. LED is an abbreviation of Light Emitting Diode.

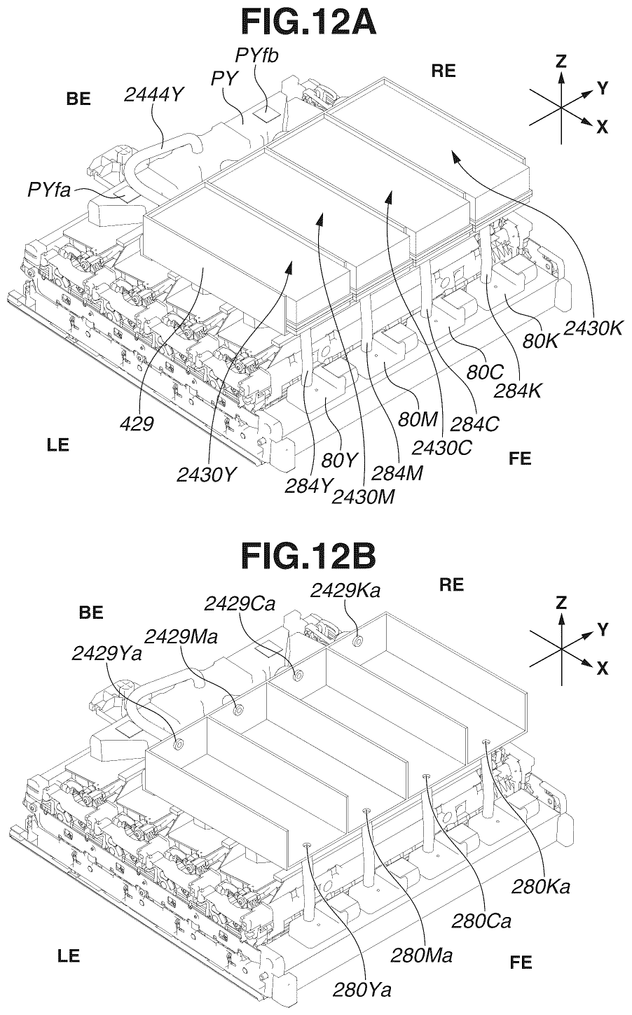

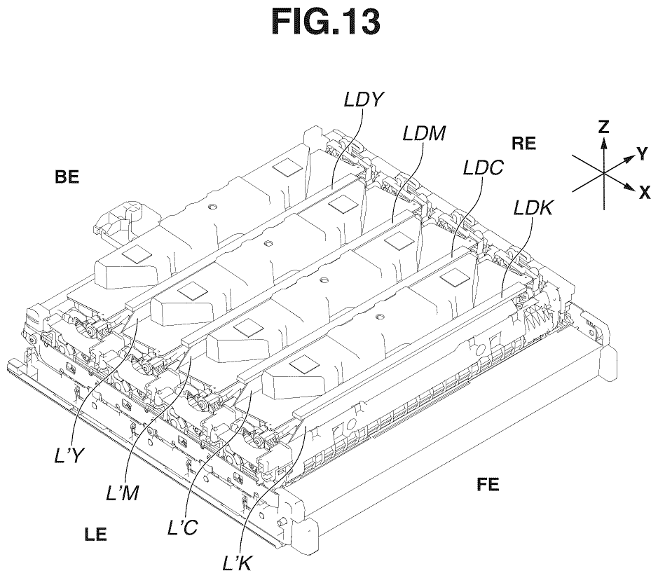

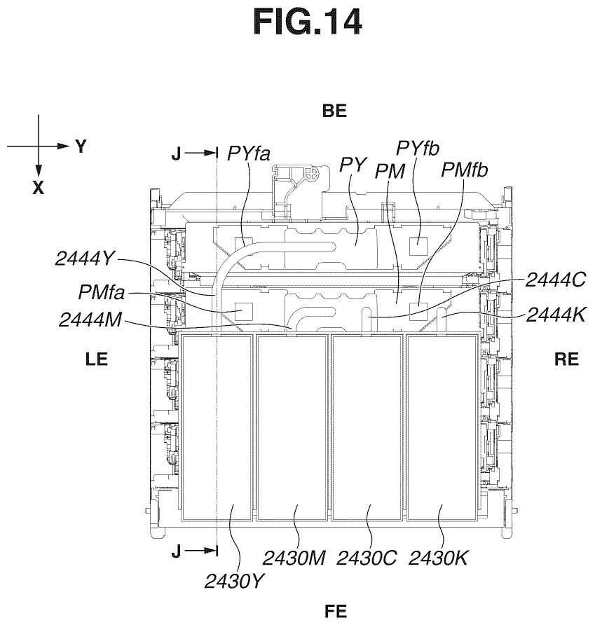

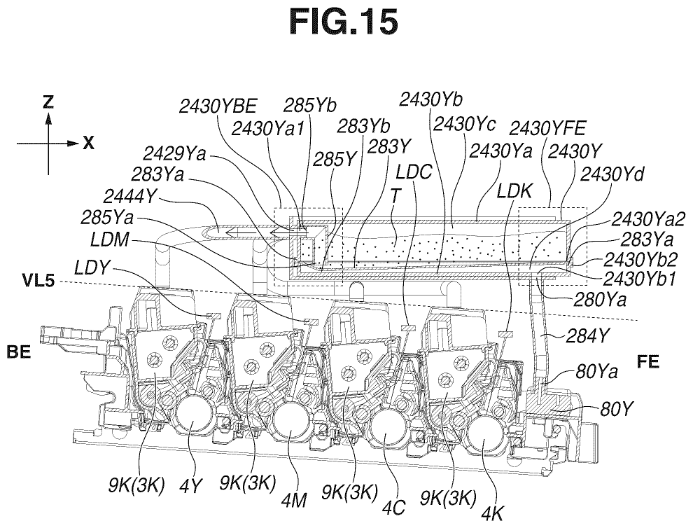

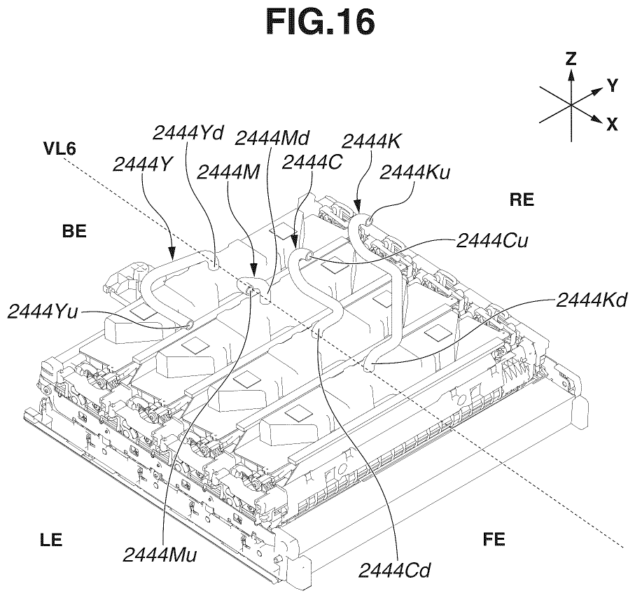

FIG. 12A is a perspective view of an image forming unit 500 with cartridges 2430 attached. FIG. 12B is a perspective view of the image forming unit 500 with the cartridges 2430 detached. FIG. 13 is a perspective view of the image forming unit 500 with the optical paths of light L′ from respective LED units LD illustrated. FIG. 14 is a view of the image forming unit 500 in a Z direction. FIG. 15 is a sectional view taken along line J-J of FIG. 14. FIG. 16 is a perspective view of the image forming unit 500 with the layout of replenishment pipes 2444 illustrated.

Each LED unit LD includes a wiring board on which an LED array and a driver integrated circuit (IC) are mounted, and a rod lens array. The LED array is a compound semiconductor chip where a plurality of light-emitting units is integrated. The driver IC is a semiconductor chip where driving elements for controlling the lighting operation of the light-emitting units in the LED array are integrated. The rod lens array is a lens constituted by arranging and fixing gradient-index fibers in an array, with an imaging characteristic of forming an erect real image at 1:1 magnification. The LED units LD are located below the top surfaces (imaginary line VL5 in FIG. 15) of the process units P in a height direction (third direction Z), with the direction of the rotation axes of photosensitive drums 4 (second direction Y) as their longitudinal direction. With such arrangement, the cartridges 2430 can be located above the process units P without occluding the optical paths of the light L′. The imaginary line VL5 is an imaginary line that passes through the top surfaces of the developing units 9 as viewed in the second direction Y.

As illustrated in FIG. 12A, the cartridges 2430 are arranged in the second direction Y orthogonal to a first direction X in which the process units P are arranged. In the first exemplary embodiment, the process units P and the cartridges 430 do not overlap as viewed from above (third direction Z). In the present exemplary embodiment, the cartridges 2430 can be arranged even over the process units P. The process units P and the cartridges 2430 thus overlap as viewed in the third direction Z. The capacities of the cartridges 2430 in the first direction X can thereby be increased to increase the amounts of toner that can be accommodated. The cartridges 2430 can be arranged with the first direction X as their longitudinal direction. As illustrated in FIG. 14, the cartridges 2430 overlap a process unit PM and a process unit PK when viewed in the third direction Z. Arranging the cartridges 2430 to overlap the process unit PK that is the closest to the front side of the main body among the process units P as viewed in the third direction Z also improves accessibility to the cartridges 2430. As illustrated in FIG. 15, the cartridge 2430Y is located on the opposite side of an LED unit LDK from a photosensitive drum 4K and on the opposite side of an LED unit LDC from a photosensitive drum 4C in the third direction.

As illustrated in FIG. 12B, openings that expose discharge ports 280Ya, 280Ma, 280Ca, and 280Ka (hereinafter referred to as discharge ports 280a) for discharging air generated (sent out) by respective pump units 80 are formed in the portion of a cartridge holder 2429 opposed to the bottom surfaces of the cartridges 2430. The discharge ports 280a open upward. The air discharged upward from the discharge ports 280a is supplied to the inside of the respective cartridges 2430 attached to the cartridge holder 2429. The air supplied to the inside of the cartridges 2430 is discharged to the outside of the cartridges 2430 along with toner. The internal structures of the cartridges 2430 will be described below.

The toner discharged from the cartridges 2430 with the air is received at replenishment pipes 2444Y, 2444M, 2444C, and 2444K (hereinafter referred to as replenishment pipes 2444) via receiving ports 2429Ya, 2429Ma 2429Ca, and 2429Ka (hereinafter referred to as receiving ports 2429a) formed in the cartridge holder 2429 illustrated in FIG. 12B. The replenishment pipes 2444 extend to and are connected with the respective developing units 9. The receiving ports 2429a are through holes formed through the surface of the cartridge holder 2429 opposed to the rear surfaces of the cartridges 2430. The receiving ports 2429a open in the first direction X that is the direction in which the developing units 9 are arranged. The direction in which the receiving ports 2429a open intersects the direction in which the discharge ports 280a open. As illustrated in FIG. 16, behind the portion of the cartridge holders 2429 where the receiving ports 2429a are formed, upstream ends 2444Yu, 2444Mu, 2444Cu, and 2444Ku (hereinafter referred to as upstream ends 2444u) of the replenishment pipes 2444 are connected to the cartridge holder 2429 to communicate with the respective receiving ports 2429a. As illustrated in FIG. 16, the toner received through the receiving ports 2429a is moved through the replenishment pipes 2444 from the upstream ends 2444u to downstream ends 2444Yd, 2444Md, 2444Cd, and 2444Kd (hereinafter referred to as downstream ends 2444d) by the air discharged from the respective cartridges 2430, and replenishes the developing units 9. The downstream ends 2444Yd, 2444Md, 2444Cd, and 2444Kd are connected to the central portions of the respective developing units 9 in the second direction Y.

The configuration of the cartridges 2430 will be described by using the cartridge 2430Y. Since the cartridges 2430M, 2430C, and 2430K have a structure similar to that of the cartridge 2340Y, a description thereof will be omitted. As illustrated in FIG. 15, the cartridge 2430Y includes a first frame 2430Ya, a second frame 2430Yb, a filter 283Y (first filter, first air-passing member), and a discharge duct 285Y (first discharge duct, first passage, first flow path). The first frame 2430Ya and the second frame 2430Yb according to the present exemplary embodiment are resin-molded members, but may be made of paper or the like. A discharge port 2430Ya1 (first discharge port) is formed in an end surface of the first frame 2430Ya in the first direction X. A receiving port 2430Yb1 (first receiving port, first intake port) is formed in the bottom surface of the second frame 2430Yb. The filter 283Y is disposed to partition (divide) the internal space of the cartridge 430Y formed by the first frame 2430Ya and the second frame 2430Yb into two, a toner chamber 2430Yc (first chamber) and an air chamber 2430Yd (second chamber). In other words, the air chamber 2430Yd adjoins the toner chamber 2430Yc via the filter 283Y. The toner chamber 2430Yc is located above the air chamber 2430Yd and aligned with the air chamber 2430Yd in the third direction Z. In other words, the attachment posture of the cartridge 2430Y relative to an apparatus main body 72 is oriented such that the toner chamber 2430Yc is located above the air chamber 2430Yd. The alignment direction of the toner chamber 2430Yc and the air chamber 2430Yd is the third direction Z. In the present exemplary embodiment, the receiving port 2430Yb1 thus opens in this alignment direction, and the discharge port 2430Ya1 opens in a direction intersecting the alignment direction. The toner chamber 2430Yc is configured to accommodate toner T. In the toner chamber 2430Yc, the toner T is supported by the filter 283Y. The air chamber 2430Yd does not accommodate any toner. The filter 283Y includes a porous member made of resin fibers, for example, and has pore size and density that allow passage of air and prevent passage of toner. In other words, the filter 283Y is configured to allow the passage of air and prevent the passage of toner. As illustrated in FIG. 15, the filter 283Y is held by the first frame 2430Ya and the second frame 2430Yb with its outer edge portion 283Ya sandwiched between a flange portion 2430Ya2 of the first frame 2430Ya and a flange portion 2430Yb2 of the second frame 2430Yb. The filter 283Y slopes from the outer edge portion 283Ya toward a lowermost portion 283Yb located below the outer edge portion 283Ya. In other words, the filter 283Y includes portions (sloping portions) that decline as they extend toward (approach) the lowermost portion 283Yb in the first direction X, the second direction Y, or a horizontal direction. The lowermost portion 283Yb is the portion protruding from the outer edge portion 283Ya in the direction from the toner chamber 2430Yc toward the air chamber 2430Yd. As illustrated in FIG. 15, the lowermost portion 283Yb is located in an end portion of the filter 283Y on the side closer to the discharge port 2430Ya1 than the receiving port 2430Yb1 in the first direction. A filter molded in such a shape is used as the filter 283Y. The toner chamber 2430Yc includes the discharge duct 285Y (passage). The discharge duct 285Y according to the present exemplary embodiment is a resin-molded member, but may be made of paper, rubber, or the like. The discharge duct 285Y is a duct that has an inlet 285Ya (first opening) and an outlet 285Yb (second opening) and extends from the inlet 285Ya to the outlet 285Yb. The discharge duct 285Y is a passage through which the toner T accommodated in the toner chamber 2430Yc passes when being moved toward the discharge port 2430Ya1. The outlet 285Yb of the discharge duct 285Y is connected to the discharge port 2430Ya1 for communication. The inlet 285Ya of the discharge duct 285Y is opposed to the lowermost portion 283Yb, which is a part of the filter 283Y, with a gap therebetween. The inlet 285Ya is desirably close to the filter 283Y. When the remaining level of the toner T in the toner chamber 2430Yc becomes low, the toner T fluidized by the air received through the receiving port 2430Yb1 moves along the slopes of the filter 283Y described above and collects to the lowermost portion 283Yb. The inlet 285Ya of the discharge duct 285Y can guide the toner T collecting to the lowermost portion 283Yb of the filter 283Y to the discharge port 2430Ya1. The toner T can thus be efficiently discharged to the outside of the cartridge 2430Y even when the remaining level of the toner accommodated in the toner chamber 2430Yc of the cartridge 2430Y is low.

The toner conveyance mechanism from the cartridge 2430Y to the process unit PY in the present exemplary embodiment includes an air replenishment pipe 284Y since the distance from the discharge port 280Ya of the pump unit 80Y to the receiving port 2430Yb1 of the cartridge holder 2429 is large. The air replenishment pipe 284Y connects the discharge port 280Ya and the receiving port 2430Yb1.

As illustrated in FIG. 15, the intake port 2430Yb1 of the cartridge 2430Y is formed in a first end portion 2430YFE of the cartridge 2430Y in the first direction X. Similarly, an intake port 2430Mb1 is formed in a second end portion of the cartridge 2430M in the first direction X. The end portion 2430YFE and the second end portion are the end portions of the cartridges 2430Y and 2430M closer to pump units 80Y and 80M, respectively. The discharge port 2430Ya1 of the cartridge 2430Y is formed in a third end portion 2430YBE of the cartridge 2430Y opposite to the first end portion 2430YFE. Similarly, the discharge port 2430Ma1 of the cartridge 2430M is formed in a fourth end portion of the cartridge 2430M opposite to the second end portion. The intake ports and discharge ports of the cartridges 2430M and 2430K are also similarly configured.

The configuration where the toner T discharged from the discharge port 2430Ya1 of the cartridge 2430 by air replenishes the developing unit 9Y (developing container 3Y) of the process unit PY through the replenishment pipe 2444Y is similar to that in the first exemplary embodiment.

In the first exemplary embodiment, the cartridges 430 are located on the front side of the main body, and the replenishment pipes 444 are located at the ends in the second direction Y to not occlude the optical paths of the laser light L from the laser scanner unit LB. In the present exemplary embodiment, as illustrated in FIG. 16, the discharge ports of the cartridges 2430 are located above the process units P, and the replenishment pipes 2444 do not need to be arranged to avoid the light L′. The replenishment pipes 2444 can thus be laid out in shorter paths than those of the first exemplary embodiment. Shortening the replenishment pipes 2444 in length can reduce the pressure loss compared to the configuration of the first exemplary embodiment.

The present disclosure is not limited to the foregoing exemplary embodiments, and various changes and modifications can be made without departing from the spirit and scope of the present disclosure. The following claims are therefore appended to make the scope of the present disclosure public.

This application claims the benefit of Japanese Patent Application No. 2023-039200, filed Mar. 14, 2023, which is hereby incorporated by reference herein in its entirety.

According to the present disclosure, a new form of image forming apparatus that conveys toner with air and toner container that is used therein can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. An image forming apparatus for forming an image on a recording material, comprising:
an apparatus main body including a first developing unit and a second developing unit, the first developing unit including a first developing container configured to accommodate first toner and a first developing roller configured to bear the first toner, the second developing unit including a second developing container configured to accommodate second toner and a second developing roller configured to bear the second toner;
a pump unit configured to send out air;
a first toner container configured to accommodate the first toner and be detachably attachable to the apparatus main body, the first toner container including a first intake port configured to take in the air sent out from the pump unit and a first discharge port configured to discharge the first toner using the air taken in from the first intake port;
a second toner container configured to accommodate the second toner and be detachably attachable to the apparatus main body, the second toner container including a second intake port configured to take in the air sent out from the pump unit and a second discharge port configured to discharge the second toner using the air taken in from the second intake port;
a first passage communicating with the first discharge port and extending to the first developing container; and
a second passage communicating with the second discharge port and extending to the second developing container,
wherein the image forming apparatus is configured such that the first toner discharged from the first discharge port is passed through the first passage to replenish the first developing container by the air discharged from the first discharge port and flowed into the first passage, and
wherein the image forming apparatus is configured such that the second toner discharged from the second discharge port is passed through the second passage to replenish the second developing container by the air discharged from the second discharge port and flowed into the second passage.

2. The image forming apparatus according to claim 1,
wherein the first developing unit and the second developing unit are arranged in a first direction, and
wherein the first toner container and the second toner container are arranged in a second direction intersecting the first direction.

3. The image forming apparatus according to claim 2, wherein the first toner container and the second toner container are both located to overlap the first developing unit as viewed in the first direction.

4. The image forming apparatus according to claim 2, wherein the first toner container and the second toner container are both located to overlap the second developing unit as seen in the first direction.

5. The image forming apparatus according to claim 2, wherein the first toner container and the second toner container are both configured to be detachably attachable to the apparatus main body in the first direction.

6. The image forming apparatus according to claim 1,
wherein the first discharge port is formed in a downstream end surface of the first toner container in an attachment direction of the first toner container relative to the apparatus main body, and
wherein the second discharge port is formed in a downstream end surface of the second toner container in an attachment direction of the second toner container relative to the apparatus main body.

7. The image forming apparatus according to claim 1,
wherein the first intake port is formed in a bottom surface of the first toner container, and
wherein the second intake port is formed in a bottom surface of the second toner container.

8. The image forming apparatus according to claim 6,
wherein the first intake port is formed in a bottom surface of the first toner container, and
wherein the second intake port is formed in a bottom surface of the second toner container.

9. The image forming apparatus according to claim 2, further comprising a discharge roller configured to discharge the recording material on which the image is formed to outside of the image forming apparatus,
wherein in a discharge direction in which the recording material is discharged by the discharge roller, the second developing unit is located downstream of the first developing unit, and the first toner container and the second toner container are located downstream of the second developing unit.

10. The image forming apparatus according to claim 9, wherein the first passage is located outside the second passage in the second direction and has a length greater than a length of the second passage in the first direction.

11. The image forming apparatus according to claim 2,
wherein the apparatus main body includes a first photosensitive drum configured to be supplied with the first toner from the first developing roller, a second photosensitive drum configured to be supplied with the second toner from the second developing roller, and an exposure unit configured to expose the first photosensitive drum and the second photosensitive drum, and
wherein the first passage and the second passage are located outside an optical path of the exposure unit in the second direction.

12. The image forming apparatus according to claim 11, wherein the second passage is located between the exposure unit and the first developing unit in a third direction intersecting both the first direction and the second direction.

13. The image forming apparatus according to claim 11, wherein at least a part of the second passage overlaps the first passage as viewed in the second direction.

14. A toner container comprising:
a first chamber configured to accommodate toner, the first chamber including a discharge port configured to discharge the toner accommodated in the first chamber to outside of the toner container;
a filter configured to prevent passage of the toner and allow passage of air;
a second chamber adjoining the first chamber via the filter, the second chamber including an intake port configured to take in air from the outside of the toner container; and
a passage disposed in the first chamber and configured for the toner to pass through, the passage including a first opening opposed to a part of the filter with a gap and a second opening configured to communicate with the discharge port, the passage extending from the first opening to the second opening,
wherein the discharge port is configured to open in a direction intersecting an alignment direction in which the first chamber and the second chamber are aligned.

15. The toner container according to claim 14, wherein the intake port is formed in a bottom surface of the toner container in a case where the toner container is oriented in a direction in which the first chamber is above the second chamber.

16. The toner container according to claim 14, wherein the filter is configured to, in a case where the toner container is oriented in a direction in which the first chamber is above the second chamber, slope downward toward the part of the filter in the alignment direction.

17. The toner container according to claim 16, wherein, in the case where the toner container is oriented in a direction in which the first chamber is above the second chamber, the part of the filter is located in a horizontal center of the filter.

18. The toner container according to claim 14, wherein the intake port is located to not overlap the first opening as viewed in the alignment direction.

19. The toner container according to claim 14, further comprising:
a first frame in which the discharge port is formed; and
a second frame in which the intake port is formed,
wherein the filter is located between the first frame and the second frame,
wherein the first chamber is formed by the first frame and the filter, and
wherein the second chamber is formed by the second frame and the filter.

20. The toner container according to claim 19, wherein an outer edge portion of the filter is sandwiched between the first frame and the second frame.

21. The toner container according to claim 14, wherein the passage includes a first portion including the first opening and extending in the alignment direction, and a second portion including the second opening and extending in the intersecting direction.

22. The image forming apparatus according to claim 1,
wherein the first toner container includes
a first chamber including the first discharge port and configured to accommodate the first toner,
a first filter configured to prevent passage of the first toner and allow passage of the air, and
a second chamber adjoining the first chamber below the first chamber via the first filter, the second chamber including the first intake port, and
wherein the second toner container includes
a third chamber including the second discharge port and configured to accommodate the second toner,
a second filter configured to prevent passage of the second toner and allow passage of the air, and
a fourth chamber adjoining the third chamber below the third chamber via the second filter, the fourth chamber including the second intake port.

23. The image forming apparatus according to claim 2,
wherein the first intake port is formed in a first end portion of the first toner container on a side closer to the pump unit in the first direction, and
wherein the second intake port is formed in a second end portion of the second toner container on a side closer to the pump unit in the second direction.

24. The image forming apparatus according to claim 23,
wherein the first discharge port is formed in a third end portion of the first toner container opposite to the first end portion in the first direction, and
wherein the second discharge port is formed in a fourth end portion of the second toner container opposite to the second end portion in the first direction.

25. The image forming apparatus according to claim 23,
wherein the first toner container is disposed such that the first direction is a longitudinal direction of the first toner container, and
wherein the second toner container is disposed such that the first direction is a longitudinal direction of the second toner container.

26. The image forming apparatus according to claim 25, wherein, in a case where the image forming apparatus is viewed in a third direction intersecting both the first direction and the second direction, the first toner container overlaps both the first developing unit and the second developing unit, and the second toner container overlaps both the first developing unit and the second developing unit.

27. The image forming apparatus according to claim 2, further comprising a discharge roller configured to discharge the recording material on which the image is formed to outside of the image forming apparatus,
wherein, in a discharge direction in which the recording material is discharged by the discharge roller, the second developing unit is located downstream of the first developing unit, and
wherein the first toner container and the second toner container overlap the second developing unit as viewed in a third direction intersecting both the first direction and the second direction.

28. The image forming apparatus according to claim 27,
wherein the apparatus main body includes a plurality of developing units including the first developing unit and the second developing unit, and
wherein the second developing unit is located most downstream in the discharge direction among the plurality of developing units.

29. The image forming apparatus according to claim 28, wherein the first toner container and the second toner container overlap the first developing unit as viewed in the third direction.

30. The image forming apparatus according to claim 1,
wherein the pump unit includes a first pump configured to send out air toward the first intake port of the first toner container and a second pump configured to send out air toward the second intake port of the second toner container, and
wherein the first pump and the second pump are arranged in a direction in which the first toner container and the second toner container are arranged.

31. The image forming apparatus according to claim 30, wherein the first pump and the second pump overlap the first toner container and the second toner container, respectively, as viewed in a gravitational direction.

32. The image forming apparatus according to claim 31, wherein the first pump and the second pump are diaphragm pumps.

33. The image forming apparatus according to claim 2,
wherein the apparatus main body includes a first photosensitive drum configured to be supplied with the first toner from the first developing roller, and an exposure unit configured to expose the first photosensitive drum, and
wherein the first toner container is located on an opposite side of the exposure unit from the second developing unit in a third direction intersecting both the first direction and the second direction.

34. The image forming apparatus according to claim 33, wherein the exposure unit includes a substrate on which a light-emitting diode (LED) array and a driver integrated circuit (IC) are mounted.

35. A toner container comprising:
a first chamber configured to accommodate toner, the first chamber including a discharge port configured to discharge the toner accommodated in the first chamber to outside of the toner container;
a filter configured to prevent passage of the toner and allow passage of air;
a second chamber adjoining the first chamber via the filter, the second chamber including an intake port configured to take in air from the outside of the toner container; and
a passage disposed in the first chamber and configured for the toner to pass through, the passage including a first opening opposed to a part of the filter with a gap and a second opening configured to communicate with the discharge port, the passage extending from the first opening to the second opening,
wherein the discharge port is configured to open in an alignment direction in which the first chamber and the second chamber are aligned.

36. The toner container according to claim 35,
wherein the intake port opens in the alignment direction, and
wherein the discharge port is formed in a surface of the toner container opposite, in the alignment direction, to where the intake port is formed.

37. A toner container comprising:
a first chamber configured to accommodate toner, the first chamber including a discharge port configured to discharge the toner accommodated in the first chamber to outside of the toner container;
a filter configured to prevent passage of the toner and allow passage of air;
a second chamber adjoining the first chamber via the filter, the second chamber including an intake port configured to take in air from the outside of the toner container; and
a passage disposed in the first chamber and configured for the toner to pass through, the passage including a first opening opposed to a part of the filter with a gap and a second opening configured to communicate with the discharge port, the passage extending from the first opening to the second opening,
wherein the intake port and the discharge port are holes formed in a frame forming the first chamber and the second chamber.
